(19) United States
(12) Patent Application Publication
(10) Pub. No.: US 2020/0015467 A1
(43) Pub. Date: Jan. 16, 2020

(54) JUG LINE FISHING APPARATUS

(71) Applicant: BENNIE WEHRENBERG, Enid, OK (US)

(72) Inventor: BENNIE WEHRENBERG, Enid, OK (US)

(21) Appl. No.: 16/033,708

(22) Filed: Jul. 12, 2018

(51) Int. Cl. A01K 89/08; A01K 93/00

(52) U.S. Cl. CPC A01K 89/081; A01K 93/00

(57) ABSTRACT

A fishing apparatus that includes a float member to position the fishing apparatus at a surface of a body of water. The fishing apparatus also includes a spool apparatus. The spool apparatus includes a spool end for having fishing line wound around. The spool apparatus further includes a flange apparatus attached to the spool end for securing the fishing line and preventing the fishing line from feeding out any further than desirable. The flange apparatus includes a first flange portion positioned adjacent to the spool end. The first flange portion includes a first opening and a first slot disposed therein. The flange apparatus also includes a second flange portion positioned adjacent to the first flange portion. The second flange portion having a second opening and a second slot disposed therein.

### STATEMENT REGARDING FEDERALLY SPONSORED RESEARCH OR DEVELOPMENT

Not applicable.

### CROSS-REFERENCE TO RELATED APPLICATIONS

Not applicable.

### BACKGROUND OF THE DISCLOSURE

### 1. Field of the Disclosure

The present disclosure relates to a fishing apparatus for jug line fishing that includes a spool apparatus that controls the output of string used by the fishing apparatus.

### 2. Description of the Related Art

Jug fishing is a method of fishing that uses lines suspended from floating objects to catch fish in lakes or rivers. Typically, fishing line is tied to the floating object and just enough fishing line is used to get a hook and, optionally, a fishing weight at a specific depth in the water. If the fishing line breaks, new fishing line has to be tied off to the floating object and, again, enough fishing line has to be used to position the hook at the desired depth in the water.

Accordingly, there is a need for a fishing apparatus that can store extra fishing line and provide a quick way to extend new fishing line and secure one end of the fishing line to the fishing apparatus.

### SUMMARY OF THE DISCLOSURE

The present disclosure is directed toward an apparatus including a spool end for having fishing line wound around. The apparatus further includes a flange apparatus attached to the spool end for securing the fishing line and preventing the fishing line from feeding out any further than desirable. The flange apparatus includes a first flange portion positioned adjacent to the spool end. The first flange portion includes a first opening and a first slot disposed therein. The flange apparatus also includes a second flange portion positioned adjacent to the first flange portion. The second flange portion having a second opening and a second slot disposed therein.

The present disclosure is also directed toward a fishing apparatus that includes a float member to position the fishing apparatus at a surface of a body of water. The fishing apparatus also includes a spool apparatus. The spool apparatus includes a spool end for having fishing line wound around. The spool apparatus further includes a flange apparatus attached to the spool end for securing the fishing line and preventing the fishing line from feeding out any further than desirable. The flange apparatus includes a first flange portion positioned adjacent to the spool end. The first flange portion includes a first opening and a first slot disposed therein. The flange apparatus also includes a second flange portion positioned adjacent to the first flange portion. The second flange portion having a second opening and a second slot disposed therein.

### BRIEF DESCRIPTION OF THE DRAWINGS

FIG. 1 is a side elevation view of a fishing apparatus constructed in accordance with the present disclosure.

FIG. 2 is a perspective view of the fishing apparatus constructed in accordance with the present disclosure.

FIG. 3 is another perspective view of the fishing apparatus constructed in accordance with the present disclosure.

FIG. 4 is side elevation view of a portion of the fishing apparatus constructed in accordance with the present disclosure.

FIG. 5 is a side elevation view of a portion of the fishing apparatus constructed in accordance with the present disclosure.

FIG. 6 is a cross-sectional view of the fishing apparatus constructed in accordance with the present disclosure.

FIG. 7A is a perspective view of another portion of the fishing apparatus constructed in accordance with the present disclosure.

FIG. 7B is a perspective view of yet another portion of the fishing apparatus constructed in accordance with the present disclosure.

FIG. 7C is a side elevation view of a cross-section of the portion of the fishing apparatus shown in FIG. 6A constructed in accordance with the present disclosure.

FIG. 7D is a side elevation view of a cross-section of the portion of the fishing apparatus shown in FIG. 6B constructed in accordance with the present disclosure.

### DETAILED DESCRIPTION OF THE DISCLOSURE

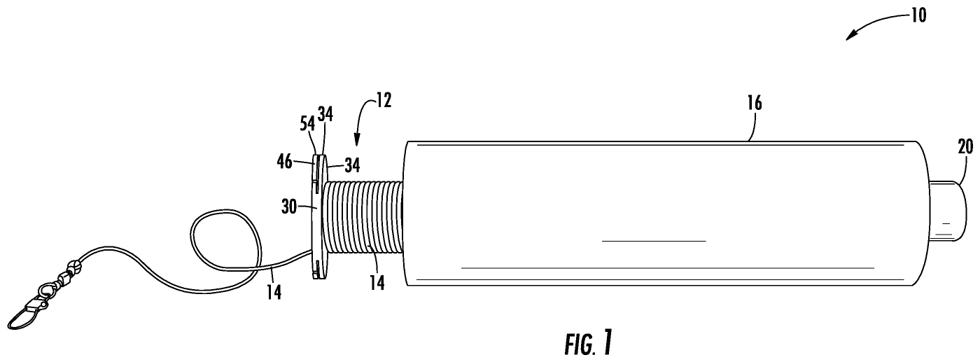

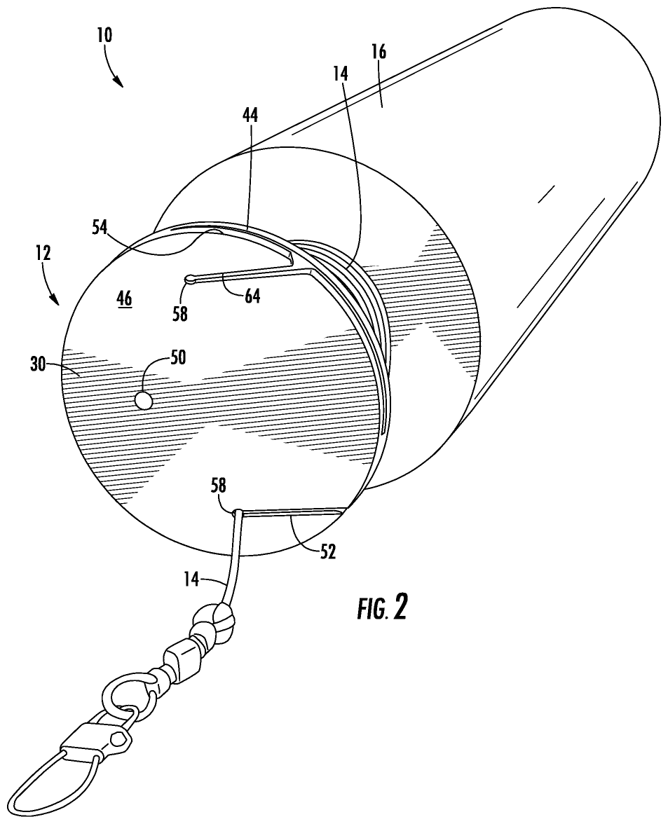

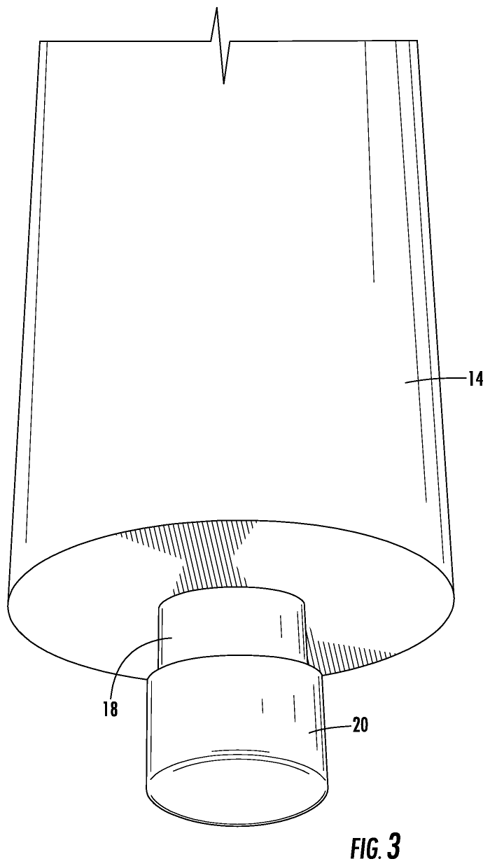

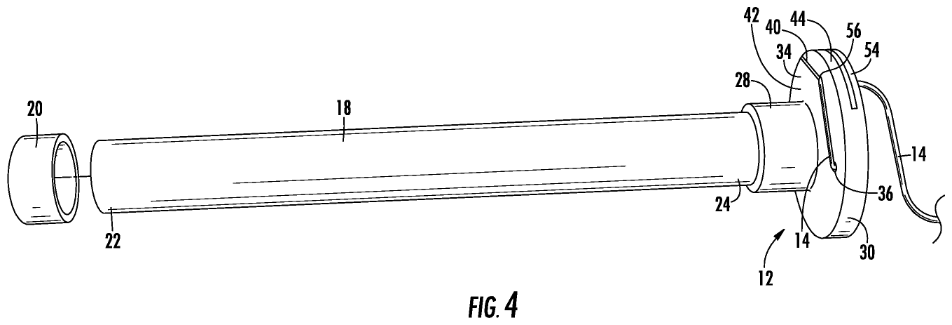

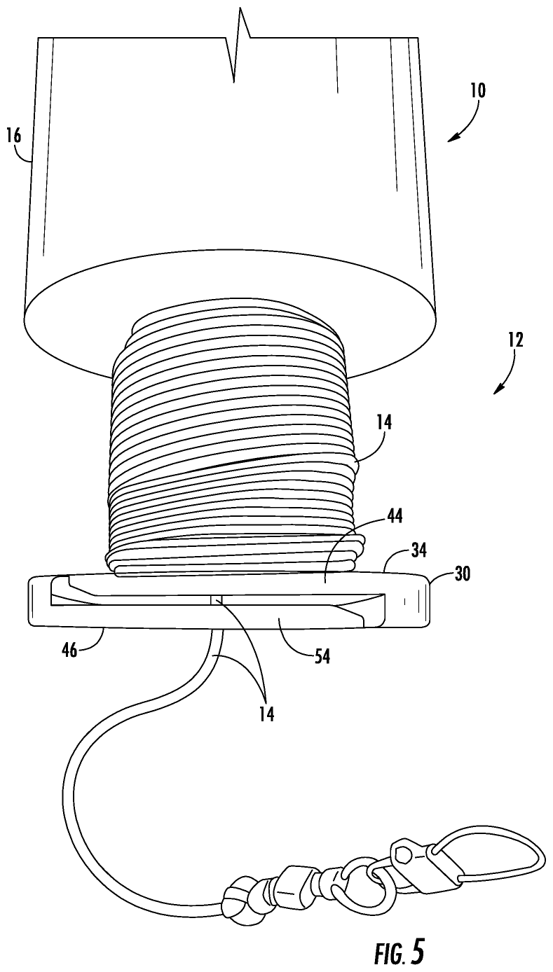

Referring now to FIGS. 1-6, shown therein is a fishing apparatus 10 for jug line fishing. The fishing apparatus 10 includes a spool apparatus 12 for supporting and controlling fishing line 14 used by the fishing apparatus 10 and a float member 16 for providing necessary buoyancy to the fishing apparatus 10.

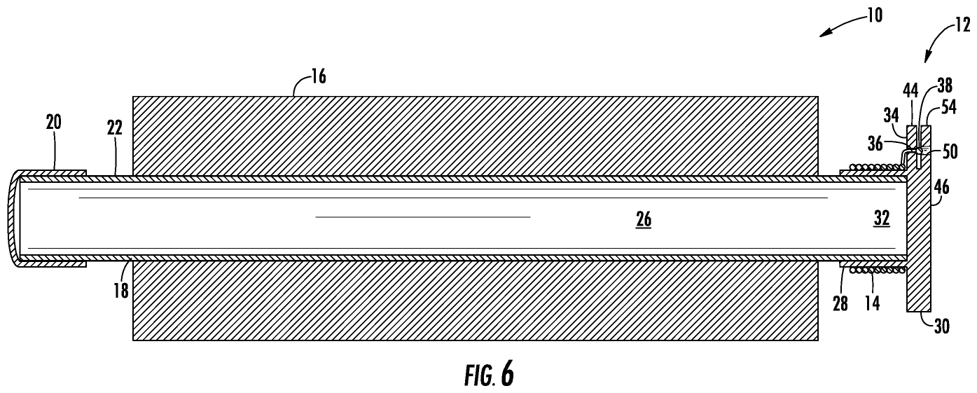

In one embodiment, the float member 16 can extend around an extension element 18 that extends from the spool apparatus 12 through at least a portion of the float member 16. In a further embodiment, the extension element 18 can be a hollow tube and extend through the float member 16 and have a cap end 20 releasably secured to a first end 22 of the extension element 18. The cap end 20 can provide a water tight seal with the first end 22 of the extension element 18. The cap end 20 can be releasably secured to the first end 22 of the extension element 18 in any manner known in the art, such as frictionally, threaded, etc. Similarly, the spool apparatus 12 can be secured to a second end 24 of the extension element 18 to create a cavity 26 (see FIG. 6) inside the extension element 18. The cavity 26 can be used to store various items needed for jug line fishing, such as more fishing line, fish hooks, fishing weights, swivels, etc. The cavity 26 is accessible via the cap end 20 of the fishing apparatus 10.

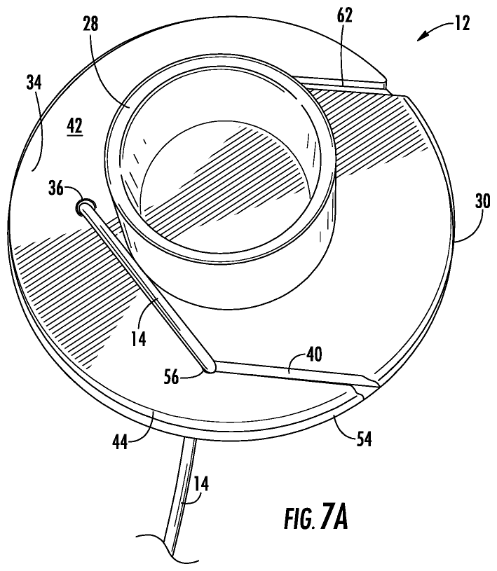

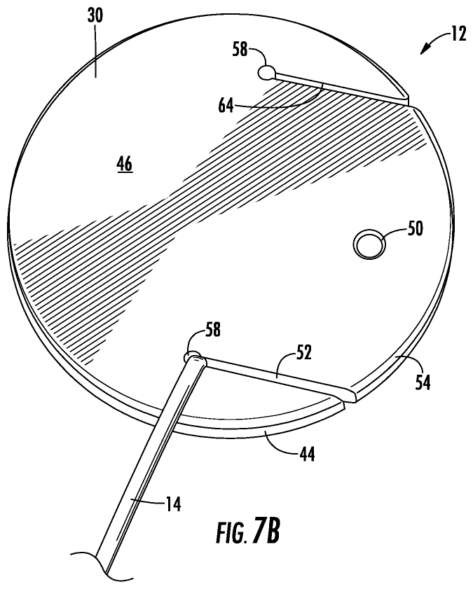

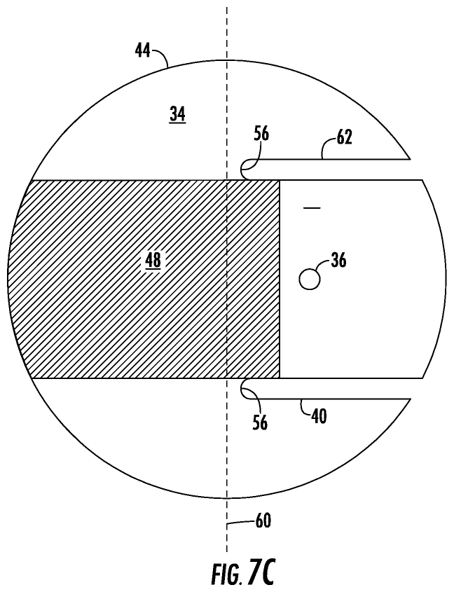

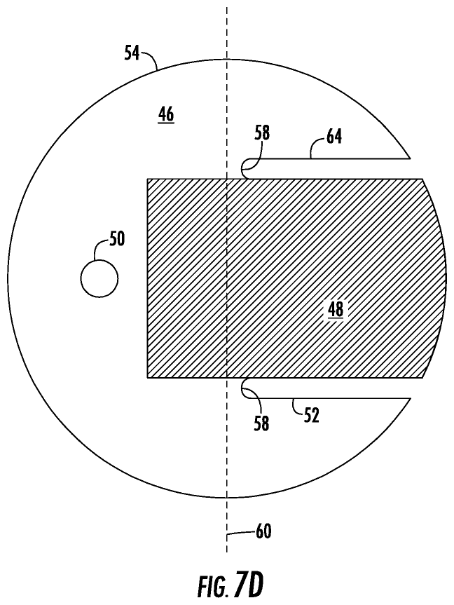

The spool apparatus 12, shown in more detail in FIGS. 7A-7C, includes a spool end 28 for giving the fishing line 14 a place to be wound up and stored for future fishing operations and a flange apparatus 30 for securing and controlling the fishing line 14. The spool end 28 can have a cavity 32 for receiving second end 24 of the extension element 18 of the fishing apparatus 10. The second end 24 of the extension element 18 can be secured in the cavity 32 of the spool end 28 of the spool apparatus 12 in any manner known in the art, such as via an adhesive material, threads, etc.

The flange apparatus 30 can include a first flange portion 34 disposed adjacent to the spool end 28 of the spool apparatus 12. The first flange portion 34 includes an opening 36 disposed therein for permitting the fishing line 14 to pass through, but is sized such that a knot 38 in the fishing line 14 cannot pass through. The first flange portion 34 also includes a slot 40 disposed therein for accepting the fishing line 14 that extends from the opening 36 in the first flange portion 34. The slot 40 extends from an outer edge 44 of the first flange portion 34. The knot 38 in the fishing line 14 would be disposed on a first side 42 of the first flange portion 34. The fishing line 14 would extend from the knot 38, pass through the opening 36 in the first flange portion 34 and through the slot 40 in the first flange portion 34.

The flange apparatus 30 can also include a second flange portion 46 connected to and disposed adjacent to the first flange portion 34 of the spool apparatus 12 via a connection member 48. The connection member 48 can be any size and shape such that the operation of the flange apparatus is not negatively affected. The second flange portion 46 includes an opening 50 disposed therein for permitting the fishing line 14 and the knot 38 to pass through. The second flange portion 46 also includes a slot 52 disposed therein for accepting the fishing line 14 that extends from the slot 40 in the first flange portion 34. The slot 52 extends from an outer edge 54 of the second flange portion 46. The opening 50 in the second flange portion 46 is in general alignment with the opening 36 disposed in the first flange portion 34 so that the fishing line 14 can be extended through both openings 36 and 50 so the knot 38 can be tied and then pulled back through the opening 50 of the second flange portion 46. The fishing line 14 would extend from the slot 40 in the first flange portion 34 to the slot 52 in the second flange portion 46 and down into the water to position the hook at the desired depth.

The slot 40 extends from the outer edge 44 of the first flange portion 34 to a terminal end 56 and the slot 52 in the second flange portion 46 extends from the outer edge 54 of the second flange portion 46 to a terminal end 58. In one embodiment, the slots 40 and 52 are disposed in their respective flange portions 34 and 46 on the same axis wherein the terminal ends 56 and 58 do not reach a centerline 60 of the first flange portion 34 and the second flange portion 46. In another embodiment, the slots 40 and 52 are disposed in their respective flange portions 34 and 46 on the same axis wherein the terminal ends 56 and 58 extend to the centerline 60 or beyond the centerline 60 of the first flange portion 34 and the second flange portion 46. In one embodiment, the slots 40 and 52 are not on the same axis.

In a further embodiment of the present disclosure, the flange apparatus 30 includes a second slot 62 disposed in the first flange portion 34 and a second slot 64 disposed in the second flange portion 46. The second slots 62 and 64 are included as backup fishing line 14 securing options in case the slots 40 and 52 are damaged. It should be understood and appreciated that the second slots 62 and 64 operate with the opening 36 in the first flange portion 34 similar to how the slots 40 and 52 operate with the opening 36 in the first flange portion 34. In a further embodiment, the flange apparatus 30 can include additional sets of slots as backup options.

From the above description, it is clear that the present disclosure is well adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. An apparatus, the apparatus comprising:
a spool end for having fishing line wound around; and
a flange apparatus attached to the spool end for securing the fishing line and preventing the fishing line from feeding out any further than desirable, the flange apparatus comprising:
a first flange portion positioned adjacent to the spool end, the first flange portion having a first opening and a first slot disposed therein; and
a second flange portion positioned adjacent to the first flange portion, the second flange portion having a second opening and a second slot disposed therein.

2. The apparatus of claim 1 wherein the first slot disposed in the first flange portion extends from an outer edge of the first flange portion to a first terminal end of the first slot.

3. The apparatus of claim 1 wherein the second slot disposed in the second flange portion extends from an outer edge of the second flange portion to a second terminal end of the second slot.

4. The apparatus of claim 1 wherein the apparatus is attachable to a float member to permit the apparatus to be positioned at the surface of a body of water.

5. The apparatus of claim 1 wherein the first opening is sized such that a knot in the fishing line will not pass therethrough.

6. The apparatus of claim 1 further comprising a third slot disposed in the first flange portion and a fourth slot disposed in the second flange portion.

7. The apparatus of claim 6 wherein the third slot disposed in the first flange portion extends from the outer portion of the first flange portion to a third terminal end and fourth slot disposed in the second flange portion extends from the outer portion of the second flange portion to a fourth terminal end.

8. A fishing apparatus, the apparatus comprising:
a float member to position the fishing apparatus at a surface of a body of water; and
a spool apparatus for controlling the extension of fishing line, the spool apparatus comprising:
a spool end for having fishing line wound around; and
a flange apparatus attached to the spool end for securing the fishing line and preventing the fishing line from feeding out any further than desirable, the flange apparatus comprising:
a first flange portion positioned adjacent to the spool end, the first flange portion having a first opening and a first slot disposed therein; and
a second flange portion positioned adjacent to the first flange portion, the second flange portion having a second opening and a second slot disposed therein.

9. The apparatus of claim 8 wherein the fishing apparatus further comprises an extension element that extends through the float element and from the spool apparatus.

10. The apparatus of claim 9 wherein the extension element is hollow to create a cavity that can be used for storage.

11. The apparatus of claim 10 further comprising a cap end disposed on an end of the extension element opposite the spool apparatus.

12. The apparatus of claim 8 wherein the first slot disposed in the first flange portion extends from an outer edge of the first flange portion to a first terminal end of the first slot.

13. The apparatus of claim 8 wherein the second slot disposed in the second flange portion extends from an outer edge of the second flange portion to a second terminal end of the second slot.

14. The apparatus of claim 8 wherein the apparatus is attachable to a float member to permit the apparatus to be positioned at the surface of a body of water.

15. The apparatus of claim 8 wherein the first opening is sized such that a knot in the fishing line will not pass therethrough.

16. The apparatus of claim 8 further comprising a third slot disposed in the first flange portion and a fourth slot disposed in the second flange portion.

17. The apparatus of claim 16 wherein the third slot disposed in the first flange portion extends from the outer portion of the first flange portion to a third terminal end and fourth slot disposed in the second flange portion extends from the outer portion of the second flange portion to a fourth terminal end.
